(19) United States
(12) Patent Application Publication
(10) Pub. No.: US 2013/0166357 A1
(43) Pub. Date: Jun. 27, 2013

(54) RECOMMENDER ENGINE

(71) Applicants: Holger Eggs, Lahr (DE); Matthias Allgaier, Karlsruhe (DE); Wolfgang Faisst, Ettlingen (DE); Thorsten Liebermann, Bensheim (DE); Alexandru Dorin Oprea, Karlsruhe (DE); Thorsten Sandfuchs, Karlsruhe (DE); Stefan Wenzel, Heidelberg (DE)

(72) Inventors: Holger Eggs, Lahr (DE); Matthias Allgaier, Karlsruhe (DE); Wolfgang Faisst, Ettlingen (DE); Thorsten Liebermann, Bensheim (DE); Alexandru Dorin Oprea, Karlsruhe (DE); Thorsten Sandfuchs, Karlsruhe (DE); Stefan Wenzel, Heidelberg (DE)

(21) Appl. No.: 13/332,761

(22) Filed: Dec. 21, 2011

(51) Int. Cl. G06Q 10/06

(52) U.S. Cl. 705/7.36

(57) ABSTRACT

A system may include determination of a business configuration of one or more tenants of a business application platform, determination of metadata of business applications associated with the business application platform, reception of a request from a user of the business application platform for one or more recommended business applications, and application of one or more filters to a set of business applications based on the business configuration and the metadata to determine a recommended business application from the set of business applications.

### FIELD

Some embodiments relate to business applications within a business application platform. More specifically, some embodiments relate to the addition of new business applications to a business application platform.

### BACKGROUND

Enterprise computing systems are commonly used to provide business services to business users. An enterprise computing system may provide one or more of customer relationship management, human resource management, supply chain management, accounting, or other functions to business users. The term “business application platform” will be used herein to encompass all types of computing systems for providing business services.

A business application platform may include a user interface (UI) layer, a business application layer, and one or more data sources, such as a data warehouse. The data sources may include raw business data in any format, the business application layer may provide functions for accessing and manipulating the data, and the UI layer may provide presentation of visual output to a user, and may also offer mechanisms for the user to interact with business applications of the business application layer.

A conventional business application platform may be hosted by a business in which it is used, or by another party. Examples of the latter scenario include business application platforms hosted “in the cloud” or, more specifically, business application platforms providing software as-a-service (e.g., Web Services).

A business may desire to add business applications to its business application platform in order to enjoy increased or improved functionality. Such additions are technically difficult in the case of on-site business application platforms. Cloud-based business application platforms attempt to address this difficulty by offering browser-based interfaces for selecting and purchasing additional business applications. However, in both scenarios, it remains difficult for a business to select a business application which is particularly suited to the current configuration of its business process platform. As one reason for this difficulty, technical issues regarding the suitability and the compatibility of various business applications are beyond the understanding of many businesses.

### BRIEF DESCRIPTION OF THE DRAWINGS

FIG. 1 is a block diagram of a system according to some embodiments.

FIG. 2 is a flow diagram of a process according to some embodiments.

FIG. 3 is a flow diagram of a process according to some embodiments.

FIG. 4 is a flow diagram of a process according to some embodiments.

FIG. 5 is a view of a user interface according to some embodiments.

FIG. 6 illustrates the application of filters to determine recommended business applications according to some embodiments.

FIG. 7 is a view of a user interface according to some embodiments.

FIG. 8 is a view of a user interface according to some embodiments.

FIG. 9 is a detailed block diagram of a portion of a system according to some embodiments.

FIG. 10 is a detailed block diagram of a portion of a system according to some embodiments.

FIG. 11 is a block diagram of an apparatus according to some embodiments.

### DETAILED DESCRIPTION

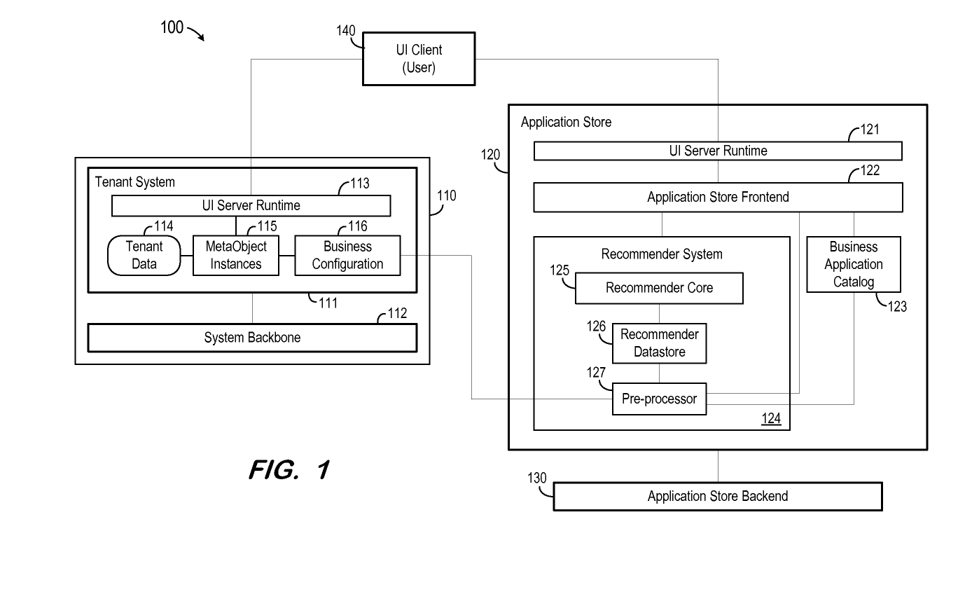

FIG. 1 is a block diagram of system 100 according to some embodiments. System 100 includes business application platform 110, application store 120, application store backend and UI client 140. Generally, business application platform 110 operates to provide business services to UI client 140. Application store 120 may allow UI client 140 to purchase additional business applications for use within business application platform 110. Moreover, application store 120 may determine recommended business applications based at least on a business configuration of business application platform 110 as will be described in detail below.

Business application platform 110 may include tenant system 111 and system backbone 112, but embodiments are not limited thereto. To provide economies of scale, tenant system 111 may provide services to a single business (i.e., tenant), and business application platform 110 may include several tenant systems, each providing services to a respective tenant. Business application platform 110 includes mechanisms to ensure that a tenant accesses only the data that the tenant is authorized to access.

Tenant system 111 includes UI server runtime 113 for interfacing with UI client 140, tenant data 114, metaobject instances 115 and business configuration 116. Tenant system 111 may include many additional components according to some embodiments, some of which are described below.

Tenant data 114 may include any data used to provide business services to the associated business. Such data may include, for example, sales order data, inventory data, shipping data, sales figures, sales projections, etc. Tenant data 114 may also include tenant-independent data which is replicated in other tenant systems of platform 100. Tenant-independent data may alternatively be stored centrally for access by each tenant system.

Tenant data 114 may reside in a physical database or stored in-memory (e.g., in Random Access Memory). The data may comprise a relational database, an in-memory database, a multi-dimensional database, an eXtendable Markup Language (XML) document, and/or any other structured data storage system. The physical tables of data 114 may be distributed among several relational databases, dimensional databases, and/or other data sources.

The structures of and relationships between the physical database tables may be complex, and platform 110 may implement metaobject instances 115 to shield developers and end-users from these complexities. A business application may access data and logic through metaobject instances 115 and, in turn, provide data to end-users through user interfaces, reports, etc. Embodiments are not limited thereto.

Metaobjects may include generic models of a business object, a floorplan (i.e., a user interface layout), user interface text, a process component, and a message type, among others. A business object, for example, is a software model representing real-world items used during the transaction of business. An instance of a business object metaobject may comprise a SalesOrder object model or an Organization object model. Instances of these object models, in turn, are referred to as objects and represent specific data (e.g., SalesOrder 4711, ACME corporation). The objects provide a mapping to the underlying tables storing the specific data associated, for example, with a particular sales order.

The metaobject instances (i.e., object models) and the instances thereof (e.g., SalesOrder 4711, ACME corporation) may be embodied in any type of data structure, including but not limited to eXtensible Markup Language files. As in the conventional storage of data, metadata defining the metaobject instances and objects may be stored in database tables and/or any other suitable format.

Business configuration 116 provides technical information regarding the business applications installed in tenant system 111. Business configuration 116 may also include any other information related to the business associated with tenant system 111. Such information may be referred to as “scoping” information and may include, but is not limited to, size, location, industry, corporate organization, resource demands, budget, number of users, number of facilities, accounting standards, etc.

Application store 120 may allow a user to purchase business applications for installation into business application platform 110. Application store 120 includes UI server runtime 121 to interface with UI client 140. In this regard, UI client 140 may comprise a Web browser and UI server runtime 121 (as well as UI server runtime 113) may comprise a Web server. UI client 140 may comprise executable code (e.g., .exe, Java, Silverlight) executing within a browser or as a standalone application.

Application store frontend 122 provides any suitable functions for viewing, selecting and purchasing one or more business applications. Application store frontend 122 may access application store backend 130 to access e-commerce functionality (financial transaction execution, security, etc.), and may access business application catalog 123 to identify business applications which are available for purchase and installation into application platform 110.

Application store frontend 122 also communicates with recommender system 124 to retrieve business application recommendations for a given user. Such business application recommendations may comprise a list of business applications, sorted according to a predicted rating calculated for each business application for the given user.

In some embodiments, recommender system 124 determines recommended business applications based on data of business configuration 116, metadata describing available business applications in catalog 123, metadata describing the user, and transactional data. Transactional data may include any data that relates a given user and a business application (e.g., purchases, leads or ratings). Recommender system 124 may therefore calculate user-specific business application recommendations leveraging knowledge-based filters which use rules to evaluate profile data, and collaborative filters which calculate similarities between users and between business applications. Details of the foregoing according to some embodiments will be provided below.

According to some embodiments, pre-processor 127 retrieves the business configuration data and the metadata, as well as user-related information from frontend 122, and stores appropriate fields thereof in recommender datastore 126. Business configuration data may be retrieved from the tenant system of the current user and also from other tenant systems of application platform 110. Recommender core 125 determines the recommended business applications from the data in datastore 126. For example, core 125 may apply one or more filters and/or rules to determine one or more recommended business applications from the business applications of catalog 123.

By virtue of the foregoing, the recommendations may be based on similarities between the current user/tenant and other users/tenants of application platform 110, and on the business applications used by the other users/tenants. Moreover, the recommendations may take into account information, such as technical configuration details and/or usage patterns, which are unavailable to existing recommendation systems.

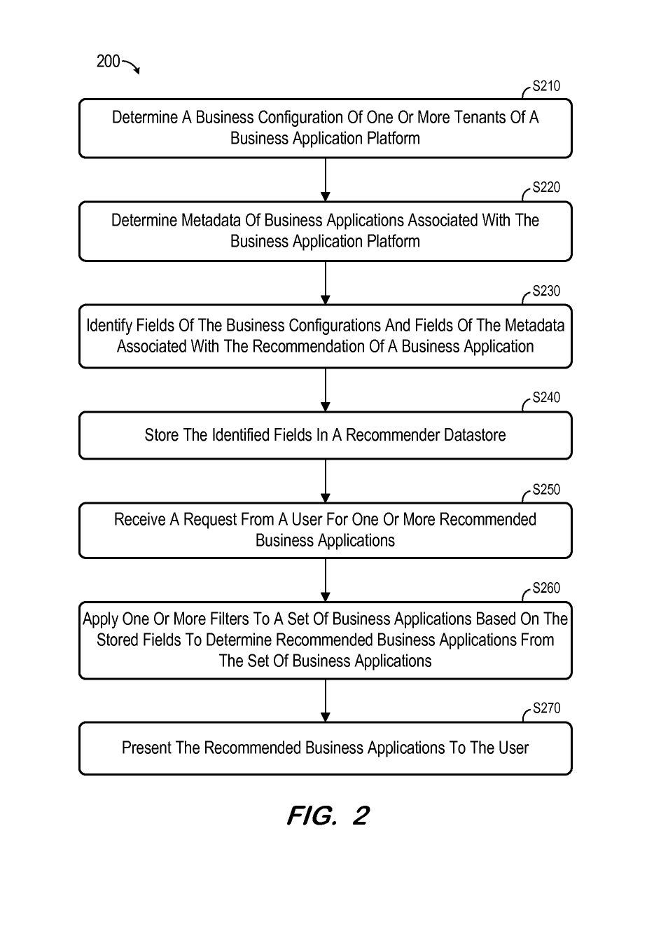

FIG. 2 is a flow diagram of a process 200 according to some embodiments. Business application platform 110 and/or application store 120 may execute portions of process 200 as will be described below, but embodiments are not limited thereto. In this regard, all processes described herein may be executed by any combination of hardware and/or software. The processes may be embodied in program code stored on a non-transitory tangible medium and executable by a computing device to provide the functions described herein. The processes described herein do not imply a fixed order to their constituent steps, and embodiments may be practiced in any order that is practicable.

Initially, at S210, a business configuration of one or more tenants of a business application platform is determined. Pre-processor 127 may, for example, retrieve business configuration (i.e., scoping) data at S210 from business configuration 116 and from any other tenant system of application platform 110. Metadata of business applications associated with the business application platform is determined at S220. Pre-processor 127 may retrieve this metadata from business application catalog 123.

Next, at S230, fields of the business configuration and of the metadata are identified. The identified fields are those which are associated with the recommendation of a business application. The identified fields are stored in a datastore, such as recommender datastore 129, at S240.

In some embodiments, pre-processor 127 may be triggered to execute S210 through S240 as part of a pre-processing algorithm, in response to a schedule (e.g., every weekday at 2 am) or in response to an instruction from an operator. In some embodiments, S210 through S240 are performed upon receipt of a request for a recommendation from UI client 140.

According to process 200, a request for one or more recommended business applications is received from a user at S250. The request may be received in any number of operational scenarios according to some embodiments. In one example, the user views currently-installed business applications within business configuration 116 through UI server runtime 113, and selects a displayed UI control to transmit the request.

In another example, a user may operate UI client 140 to access application store 120 (e.g., by inputting a Uniform Resource Locator (URL) corresponding to application store 120 into a Web browser). UI client 140 may then interact with application store frontend 124 to access an interface which allows UI client 140 to search for business applications, presumably to purchase and install those applications into business application platform 110. The entry and submission of search terms into such an interface may comprise a request for one or more recommended business application that is received at S250. The request may include any number of filtering criteria provided by the user, such as industry, topic, function, cost, etc.

Next, at S260, one or more filters are applied to a set of business applications based on the stored fields to determine recommended business applications from the set of business applications. According to one example of S260, recommender core 125 applies one or more filters to filter the applications of business application catalog 123, using information from datastore 126. The recommended business applications are then presented to the user at S270. As mentioned above, the recommended business applications may be presented in a list which is sorted by their predicted ratings or by other criteria.

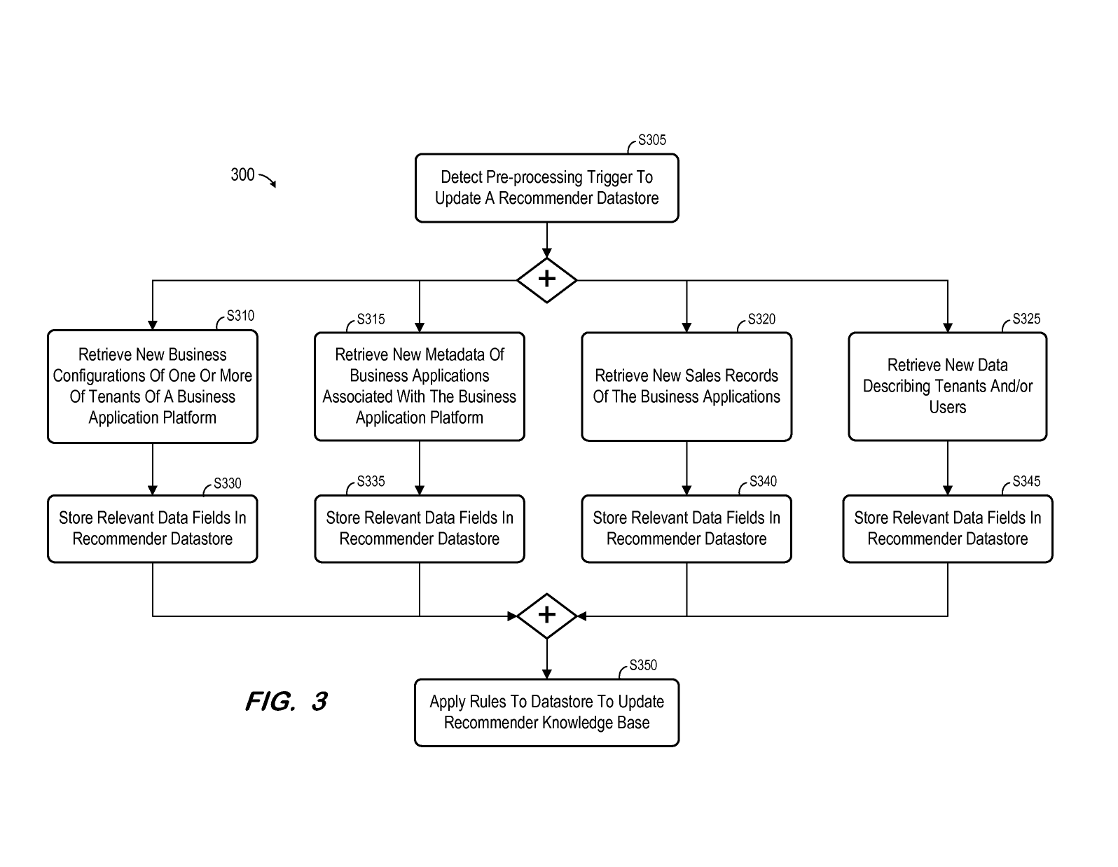

FIG. 3 is a flow diagram of process 300 according to some embodiments. Process 300 may comprise an implementation of S210 through S240 of process 200, but embodiments of either process are not limited thereto.

Initially, at S305, a pre-processing trigger to update a recommender datastore is detected. The trigger may comprise the arrival of a scheduled time (e.g., every weekday at 2 am), the detection of new business configuration data, new business application metadata, or other new data stored in application platform 110 and/or application store 120, and/or any other suitable event.

In response to the detected trigger, new business configurations of one or more tenants of a business application are retrieved at S310 and new metadata of business applications associated with the business application platform are retrieved at S315. Moreover, new sales records of the business applications are retrieved at S320 and new data describing tenants and users is retrieved at S325. With respect to the FIG. 1 architecture, pre-processor 127 may retrieve the new business configurations from business configuration 116, and the new metadata from catalog 123. The sales records may be retrieved from application store backend 130 and the tenant /user data may be retrieved from application store frontend 122. “New” data, as used herein, refers to data that has been added or updated since a last execution of process 300. According to some embodiments, some or all “old” data may also be retrieved at S310 through S325.

For each type of data retrieved at S310 through S325, relevant data fields are stored in a recommender datastore at S330 through S345. The relevant data fields are those fields which may be used during subsequent determination of recommended business applications. Accordingly, a field's relevance depends upon the algorithms, filters, etc. which will be used to determine recommended business applications.

According to some embodiments, relevant data fields include, but are not limited to, Customer ID, Customer Industry, Customer Country, Scoping Configuration, User ID, Business Application ID, Business Application Industry, Business Application Needs, Business Application Dependencies, Business Application Publication Date, Number of Business Application Purchases, Business Application Price, Business Application Languages, Business Application Countries, Sales Record Customer ID, Sales Record User ID, Sales Record Business Application ID, Sales Record Date, and Sales Record Price.

Finally, at S350, pre-processing rules are applied to the datastore in order to update a knowledge base stored therein. As is known in the art, updates to a knowledge base may be calculated prior to making a determination using the knowledge base. Such pre-calculation reduces the time required to make the determination. The specific update calculations depend on the nature of the knowledge base and the filters and/or algorithms which will leverage the knowledge base. In some embodiments, calculation of the updates includes calculations of similarity matrices between users, tenants, and business applications.

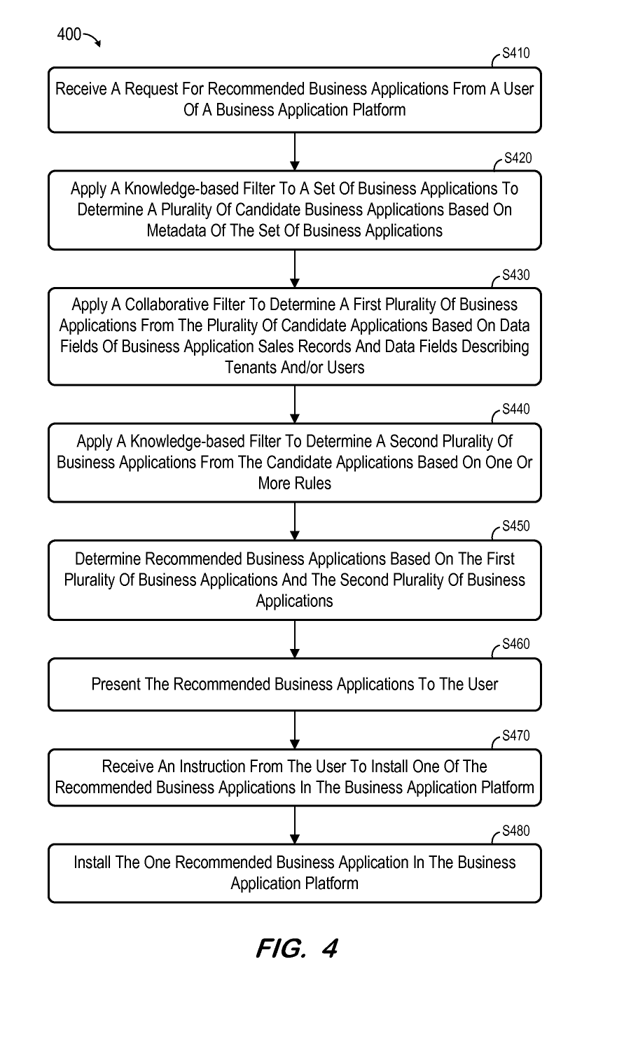

Process 400 of FIG. 4 may comprise an implementation of S250 through S270 of process 200, but embodiments of either process are not limited thereto.

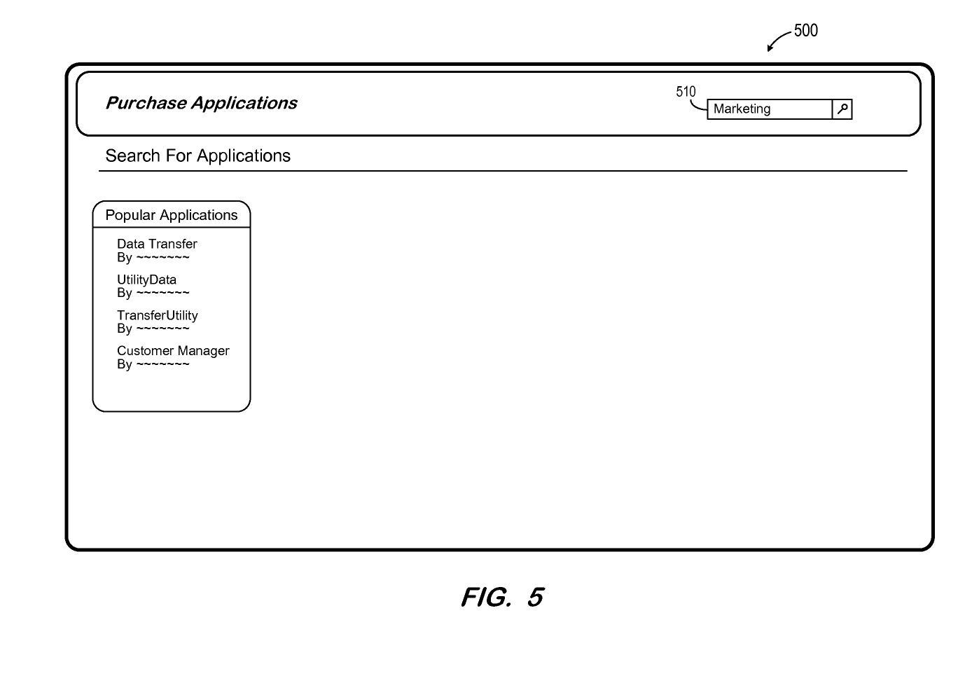

At S410, a request for one or more recommended business applications is received from a user of a business application platform. FIG. 5 illustrates interface 500 which may be provided to UI client 140 by UI server runtime 122 prior to S410 according to some embodiments. For example, a user may operate UI client 140 to access application store 120 (e.g., by inputting a Uniform Resource Locator (URL) corresponding to application store 120 into a Web browser). UI client 140 may then interact with application store frontend 124 to access interface 500, which allows UI client 140 to search for business applications, presumably to purchase and install those applications into business application platform 110. The entry and submission of search terms into input field 510 may comprise a request for recommended business applications that is received at S410.

Next, at S420, a knowledge-based filter is applied to a set of business applications to determine a plurality of candidate business applications. The filter is applied based on metadata of the set of business applications. As mentioned above, such metadata may be stored in recommender datastore 126.

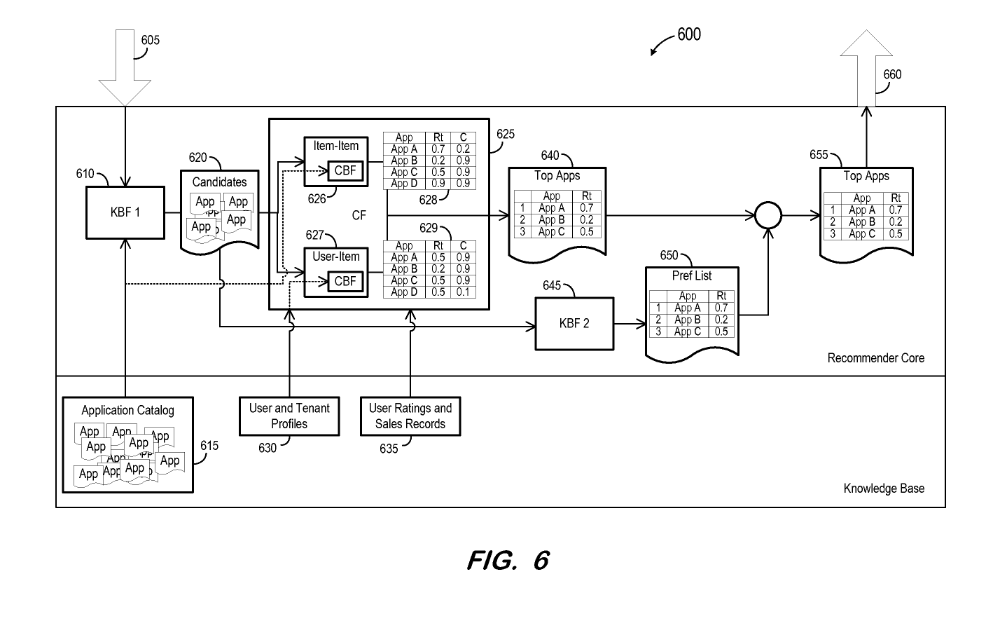

FIG. 6 is a diagram of system 600 to implement S410 through S460 according to some embodiments. Arrow 605 indicates reception of the request by a recommender core at S410. The recommender core applies knowledge-based filter 610 to the set of business applications represented in application catalog 615 of a knowledge base in order to determine candidate applications 620. The recommender core of system 600 may be implemented by recommender core 125 of system 100, and the knowledge base of system 600 may be implemented by recommender datastore 126 of system 100.

According to the illustrated embodiment, KBF 610 is intended to identify those applications of catalog 615 which should be potentially recommended to the user. For example, KBF 610 may apply basic reasoning rules which result in one of two outcomes: a business application is either part of candidates 620 or is not. User-based reasoning rules may filter application catalog 615 using data fields from the user profile (e.g., only business applications intended for the same industry as the industry of the customer are considered candidates). On the other hand, other reasoning rules may compare data fields of the business applications with constant values (e.g., only business applications which are not in beta status are considered candidates). KBF 610 may limit the processing time of subsequent filters by limiting the set of solutions over which the filters must iterate.

At S430, a collaborative filter is applied to determine a first plurality of business applications from the plurality of candidate business applications. The collaborative filter is applied based on data fields of business application sales records and data fields describing tenants and/or users. FIG. 6 shows collaborative filter 625 for use in some embodiments of S430. Collaborative filter 625 includes item-item collaborative filter 626 and user-item collaborative filter 627.

User-item collaborative filter 627 determines recommendations 628 based on users' similarity (e.g, business applications bought by users/tenants similar to the active user could be of interest to the active user). Item-item collaborative filter 626 determines recommendations 629 based on items' similarity (e.g., business applications similar to those already bought by the active user might be of interest to him).

As described above, the above-mentioned similarities may be pre-calculated during pre-processing prior to S410. The similarities may be computed in two ways: similarities based on behavior and similarities based on content. The similarities based on behavior are calculated based on user rating and/or sales records 635. If available, leads and/or browsing behavior can also be used.

Using known content-based filtering (CBF) algorithms, similarities based on content are calculated based on metadata 615 describing the business applications (in the case of item-item collaborative filter 626) and user/tenant metadata 630 (in the case of the user-item collaborative filter). For example, two business applications may be judged more similar if they address the same business needs, and two tenants may be judged more similar if they are located in the same country. These “content-based augmentations” are intended to increase the quality of the recommendations, when no or little behavioral data is available. The quality of the similarities based on behavior directly depends on the amount of behavioral data available (e.g., the number of ratings).

The two computed similarities may be combined in each filter 626 and 627 using a weighted mean. For example, the behavioral similarity may be weighted at 70% and the content-based similarity at 30%. Based on these similarities, each of user-item filter 627 and item-item filter 626 computes a rating for each business application of candidates 620. As shown in lists 628 and 629, each rating is also associated with a confidence value. The confidence is based on the number of highly-similar users/items that lead to a rating. The confidence may be used to weight the two ratings for each business application when combining them to generate sorted list of business applications 640 at S430.

In a general example,: user-item filter 627 predicts a rating of 5 stars for a particular business application, but this prediction is based on only two similar users, whereas item-item filter predicts a rating of 3 stars for the same business application, based on 20 similar solutions. Therefore, the rating associated with the business application in list 640 is closer to 3 stars then to 5 stars.

Returning to process 400, a knowledge-based filter is applied at S440 to determine a second plurality of business applications from the candidate applications. The application is based on one or more rules. Application of this filter may address situations in which very few (or zero) ratings are available to collaborative filter 625, which therefore cannot provide any meaningful recommendations. The determination at S440 may also allow the promotion of particular business applications, or to resolve ties in list 640. For example, if two business applications are associated with the same rating in list 640, the filter of S440 may be applied to rank the more-profitable business application higher.

KBF 645 therefore determines list of business applications 650, which is sorted according to predicted rating. Next, at S450, recommended business applications 655 are determined based on the first plurality of business applications 640 and the second plurality of business applications 650. Arrow 660 depicts presentation of the recommended business applications to the user at S460.

According to some embodiments, filters 625 and 645 use sales records 635 to determine a purchase likelihood for each business application, instead of (or in addition to) a predicted rating. Therefore, business applications 640 and 650 are sorted, and business applications 655 are presented, according to purchase likelihood.

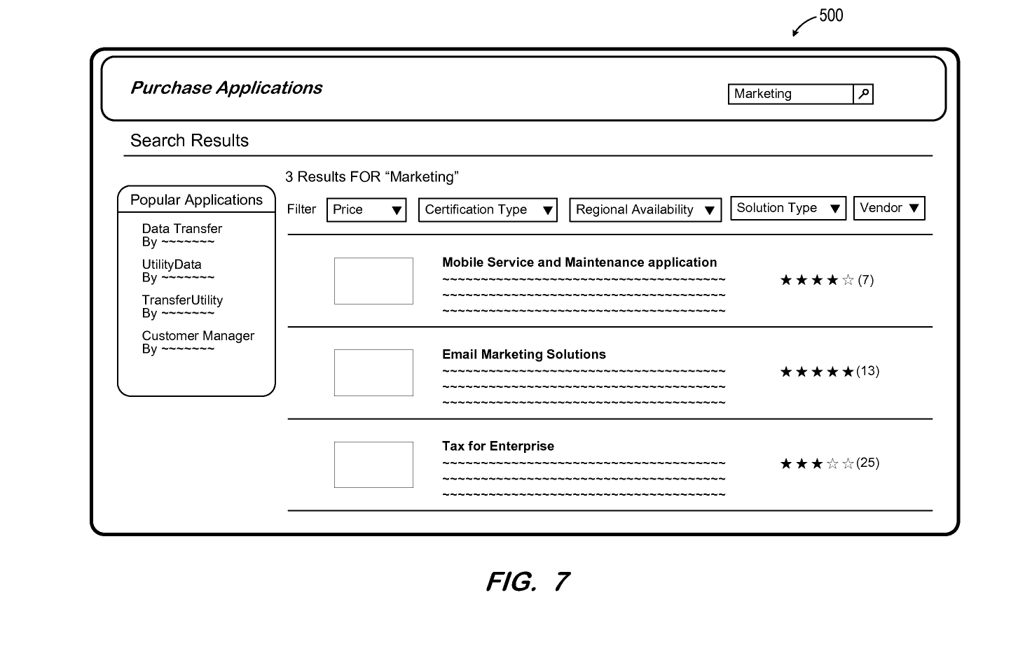

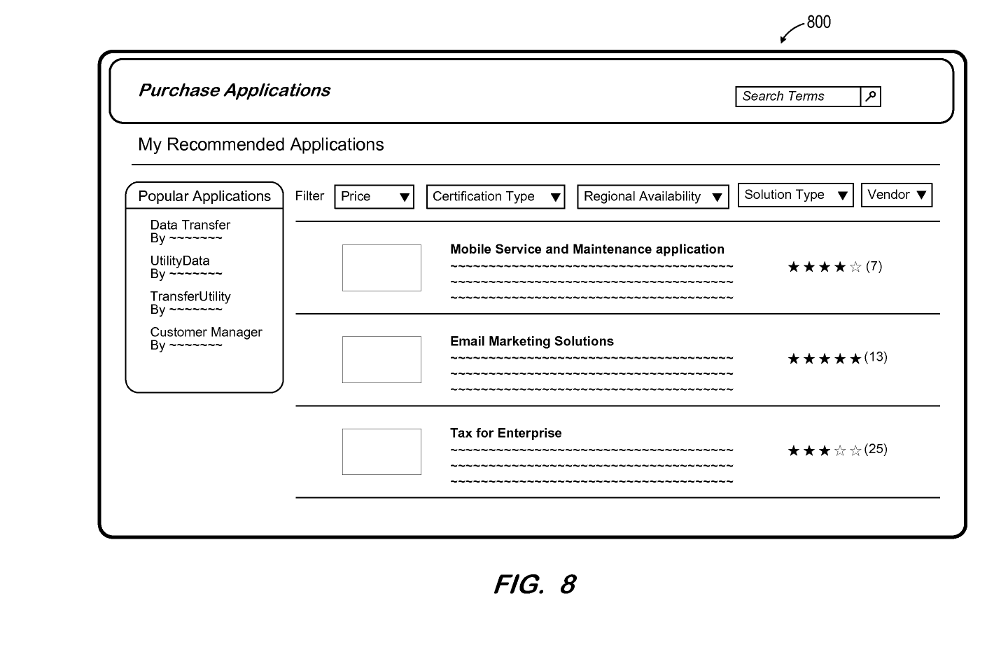

Returning to the FIG. 5 example, FIG. 7 illustrates user interface 400 after the user has searched for business applications using the term “marketing”. The presented business applications are those determined at S460, ordered by rating, and filtered on the term “marketing”. In contrast, FIG. 8 illustrates interface 800 according to some embodiments. Interface 800 may be accessed and presented as described above with respect to interface 500. Accordingly, a request for user interface 800 may be considered a request to determine a candidate business application which is received at S410. However, interface 800 displays “recommended” applications without requiring search terms from the user. Therefore, interface 800 presents the business applications determined at S460, ordered by rating and without further filtering.

Regardless of the scenario in which the recommended business applications are presented, an instruction is received from the user at S470 to install one of the recommended business applications in the business application platform. Continuing with the FIG. 7 example, the user may select any of the presented business applications in order to commence an ecommerce transaction with application store backend 130 to purchase the selected application.

After the purchase is complete, the business application is installed in the business application platform at S480. Systems for installing business applications into a business application platform are known. Contrary to known systems, however, process 400 advantageously facilitates determination and installation of recommended business applications into an existing business application platform by determining the business configuration of the business application platform directly therefrom.

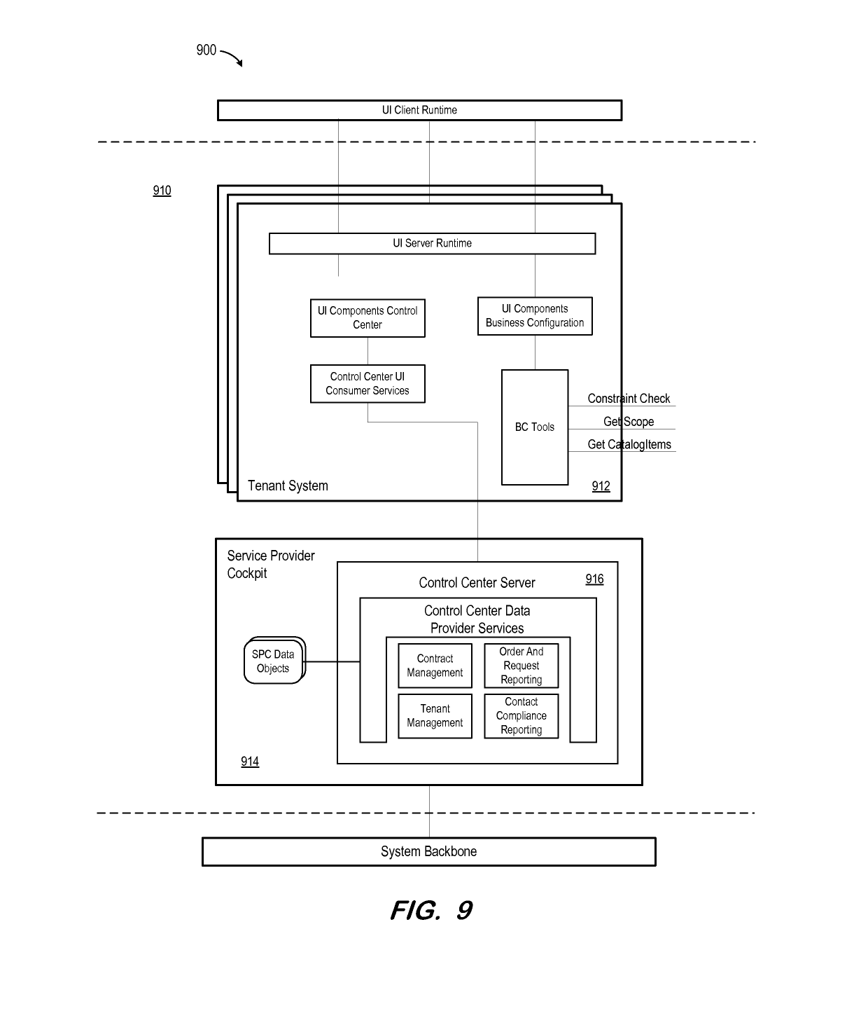

FIG. 9 is a detailed block diagram of architecture 900 according to some embodiments. Architecture 900 may comprise an implementation of the left side of system 100 of FIG. 1.

Service provider zone 910 hosts an on-demand system infrastructure, including one or more tenant systems 912. Service provider cockpit (SPC) 914 provides maintenance and coordination of the tenant systems by managing and running all tenant-related process and services.

Tenant system 914 is an on-demand system hosted by the provider of the business application platform. Tenant system 914 holds tenant data and is scoped and configured up to the tenant's demands. A tenant may, as described above, connect to his dedicated tenant system via a Web browser. A single customer may be associated with multiple tenant systems, for example, one for test and one for production.

Control center server 916 is a central component for consolidation of all process and status-related data that shall be retrievable via the customer, reseller or partner control center. Control center server 916 includes a data store storing consolidated data in process-specific business objects.

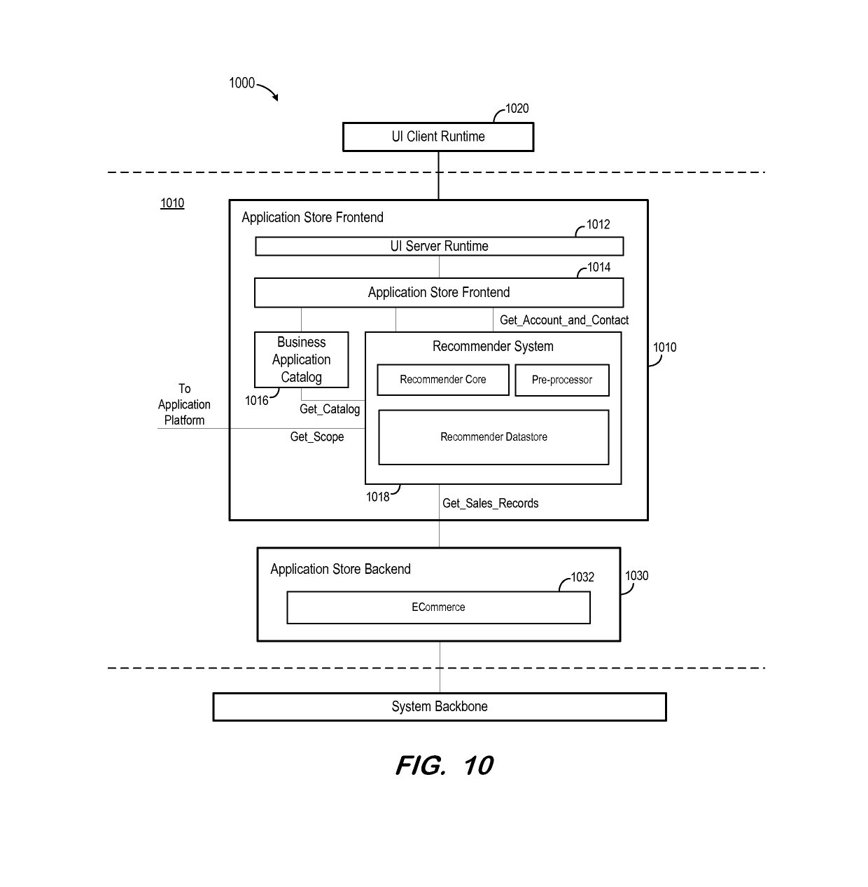

FIG. 10 is a detailed block diagram of architecture 1000 according to some embodiments. Architecture 1000 may comprise an implementation of the right side of system 100 of FIG. 1. Accordingly, embodiments of architectures 900 and 1000 may operate to execute the processes described herein.

Application store 1010 may allow a user to purchase business applications. Application store 1010 includes UI server runtime 1012 to interface with UI client runtime 1020. Application store frontend 1014 provides any suitable functions for viewing, selecting and purchasing one or more business applications. Application store frontend 1014 may access application store backend 1030 to access e-commerce functionality 1032 (financial transaction execution, security, etc.), and may access business application catalog 1016 to identify business applications which are available for purchase and installation into a business application platform.

Application store frontend 1014 also communicates with recommender system 1018 to retrieve business application recommendations. As shown, recommender system 1018 determines recommended business applications based on information from frontend 1014, catalog 1016, backend 1030 and tenant systems of an application platform.

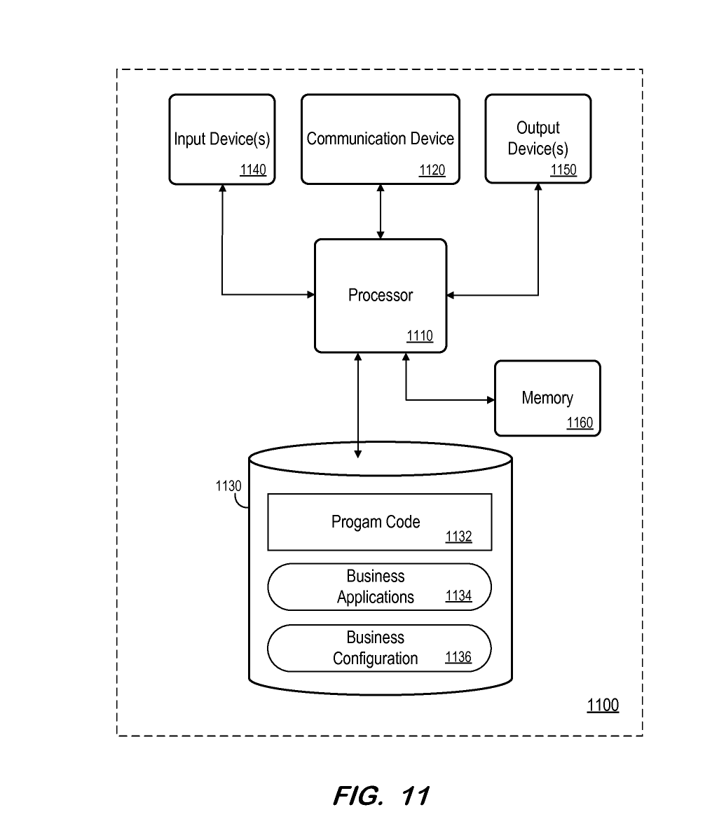

FIG. 11 is a block diagram of apparatus 1100 according to some embodiments. Apparatus 1100 may comprise a general-purpose computing apparatus and may execute program code to perform any of the functions described herein, including but not limited to processes 200, 300 and 400. Apparatus 1100 may comprise an implementation of one or more elements of system 100, architecture 900 and/or architecture 1000. Apparatus 1100 may include other unshown elements according to some embodiments.

Apparatus 1100 includes processor 1110 operatively coupled to communication device 1120, data storage device 1130, one or more input devices 1140, one or more output devices 1150 and memory 1160. Communication device 1120 may facilitate communication with external devices, such as an external design tool. Input device(s) 1140 may comprise, for example, a keyboard, a keypad, a mouse or other pointing device, a microphone, knob or a switch, an infra-red (IR) port, a docking station, and/or a touch screen. Input device(s) 1140 may be used, for example, to enter information into apparatus 1100. Output device(s) 1150 may comprise, for example, a display (e.g., a display screen) a speaker, and/or a printer.

Data storage device 1130 may comprise any appropriate persistent storage device, including combinations of magnetic storage devices (e.g., magnetic tape, hard disk drives and flash memory), optical storage devices, Read Only Memory (ROM) devices, etc., while memory 1160 may comprise Random Access Memory (RAM).

Program code 1132 of data storage device 1130 may be executable by processor 1110 to provide any of the functions described herein, including providing a business application platform and an application store. Embodiments are not limited to execution of these functions by a single apparatus. Business applications 1134 may include any business applications as described herein, and business configuration 1136 may comprise a business configuration of a business application platform. Data storage device 1130 may also store data and other program code for providing additional functionality and/or which are necessary for operation thereof, such as device drivers, operating system files, etc.

Actual implementations of the architectures described herein may include more or different components arranged in other manners. Moreover, each component described herein may be implemented by any number of devices in communication via any number of other public and/or private networks. Two or more of such devices of may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more non-transitory computer-readable media such as, for example, a fixed disk, a floppy disk, a CD-ROM, a DVD-ROM, a flash drive, magnetic tape, and solid state RAM or ROM storage units. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, comprising:
determining a business configuration of one or more tenants of a business application platform;
determining metadata of business applications associated with the business application platform;
receiving a request from a user of the business application platform for one or more recommended business applications; and
applying one or more filters to a set of business applications based on the business configuration and the metadata to determine a recommended business application from the set of business applications.

2. A method according to claim 1, further comprising:
presenting the recommended business application to the user;
receiving an instruction from the user to install the determined business application in the business application platform; and
in response to the instruction, installing the determine business application in the business application platform.

3. A method according to claim 1, wherein receiving the request from the user comprises:
receiving a query to search a catalog of business application, and
wherein determining the first business application comprises executing the query based on the determined business configuration.

4. A method according to claim 1,
wherein determining the business configuration of one or more tenants of the business application platform comprises retrieving only new business configurations of the one or more tenants of the business application platform, and
wherein determining the metadata of business applications associated with the business application platform comprises retrieving only new metadata of business applications associated with the business application platform.

5. A method according to claim 1, further comprising:
determining fields of the business configuration associated with recommendation of a business application;
determining fields of the metadata of business applications associated with recommendation of a business application; and
storing the determined fields of the business configuration and the determined fields of the metadata in a datastore,
wherein the one or more filters are applied to the set of business applications based on the fields of the business configuration and the fields of the metadata in the datastore.

6. A method according to claim 1, wherein applying the one or more filters comprises:
applying a first knowledge-based filter to the set of business applications to determine a plurality of candidate business applications based on metadata of the set of business applications;
applying a collaborative filter to determine a first plurality of business applications from the plurality of candidate business applications;
applying a second knowledge-based filter to determine a second plurality of business applications from the candidate business applications based on one or more rules; and
determining the recommended business application based on the first plurality of business applications and the second plurality of business applications.

7. A method according to claim 1, wherein applying the collaborative filter to determine the first plurality of business applications comprises:
applying the collaborative filter to determine the first plurality of business applications from the plurality of candidate business applications based on data fields of business application sales records and data fields describing tenants.

8. A non-transitory medium storing processor-executable program code, the program code executable by a device to cause the device to:
determine a business configuration of one or more tenants of a business application platform;
determine metadata of business applications associated with the business application platform;
receive a request from a user of the business application platform for one or more recommended business applications; and
apply one or more filters to a set of business applications based on the business configuration and the metadata to determine a recommended business application from the set of business applications.

9. A medium according to claim 8, the program code further executable by a device to cause the device to:
present the recommended business application to the user;
receive an instruction from the user to install the determined business application in the business application platform; and
in response to the instruction, install the determine business application in the business application platform.

10. A medium according to claim 8, wherein receipt of the request from the user comprises:
receipt of a query to search a catalog of business application, and
wherein determination of the first business application comprises execution of the query based on the determined business configuration.

11. A medium according to claim 8,
wherein determination of the business configuration of one or more tenants of the business application platform comprises retrieval of only new business configurations of the one or more tenants of the business application platform, and
wherein determination of the metadata of business applications associated with the business application platform comprises retrieval of only new metadata of business applications associated with the business application platform.

12. A medium according to claim 8, the program code further executable by a device to cause the device to:
determine fields of the business configuration associated with recommendation of a business application;
determine fields of the metadata of business applications associated with recommendation of a business application; and
store the determined fields of the business configuration and the determined fields of the metadata in a datastore,
wherein the one or more filters are applied to the set of business applications based on the fields of the business configuration and the fields of the metadata in the datastore.

13. A medium according to claim 8, wherein application of the one or more filters comprises:
application of a first knowledge-based filter to the set of business applications to determine a plurality of candidate business applications based on metadata of the set of business applications;
application of a collaborative filter to determine a first plurality of business applications from the plurality of candidate business applications;
application of a second knowledge-based filter to determine a second plurality of business applications from the candidate business applications based on one or more rules; and
determination of the recommended business application based on the first plurality of business applications and the second plurality of business applications.

14. A medium according to claim 8, wherein application of the collaborative filter to determine the first plurality of business applications comprises:
application of the collaborative filter to determine the first plurality of business applications from the plurality of candidate business applications based on data fields of business application sales records and data fields describing tenants.

15. A system comprising:
a computing device comprising:
a memory system storing processor-executable program code; and
a processor to execute the processor-executable program code in order to cause the computing device to:
determine a business configuration of one or more tenants of a business application platform;
determine metadata of business applications associated with the business application platform;
receive a request from a user of the business application platform for one or more recommended business applications; and
apply one or more filters to a set of business applications based on the business configuration and the metadata to determine a recommended business application from the set of business applications.

16. A system according to claim 15, the processor further to execute the processor-executable program code in order to cause the computing device to:
present the recommended business application to the user;
receive an instruction from the user to install the determined business application in the business application platform; and
in response to the instruction, install the determine business application in the business application platform.

17. A system according to claim 15, wherein receipt of the request from the user comprises:
receipt of a query to search a catalog of business application, and
wherein determination of the first business application comprises execution of the query based on the determined business configuration.

18. A system according to claim 15,
wherein determination of the business configuration of one or more tenants of the business application platform comprises retrieval of only new business configurations of the one or more tenants of the business application platform, and
wherein determination of the metadata of business applications associated with the business application platform comprises retrieval of only new metadata of business applications associated with the business application platform.

19. A system according to claim 15, the processor further to execute the processor-executable program code in order to cause the computing device to:
determine fields of the business configuration associated with recommendation of a business application;
determine fields of the metadata of business applications associated with recommendation of a business application; and
store the determined fields of the business configuration and the determined fields of the metadata in a datastore,
wherein the one or more filters are applied to the set of business applications based on the fields of the business configuration and the fields of the metadata in the datastore.

20. A system according to claim 15, wherein application of the one or more filters comprises:
application of a first knowledge-based filter to the set of business applications to determine a plurality of candidate business applications based on metadata of the set of business applications;
application of a collaborative filter to determine a first plurality of business applications from the plurality of candidate business applications;
application of a second knowledge-based filter to determine a second plurality of business applications from the candidate business applications based on one or more rules; and
determination of the recommended business application based on the first plurality of business applications and the second plurality of business applications.

21. A system according to claim 15, wherein application of the collaborative filter to determine the first plurality of business applications comprises:
application of the collaborative filter to determine the first plurality of business applications from the plurality of candidate business applications based on data fields of business application sales records and data fields describing tenants.
